(19) United States
(12) Patent Application Publication
(10) Pub. No.: US 2017/0372367 A1
(43) Pub. Date: Dec. 28, 2017

(54) CONTENT OUTPUT DEVICE, METHOD OF OUTPUTTING CONTENT, AND COMPUTER READABLE MEDIUM

(71) Applicant: CASIO COMPUTER CO., LTD., Tokyo (JP)

(72) Inventors: Gou KAWAKAMI, Tokyo (JP); Takashi KAWASHIMO, Tokyo (JP); Yoichi MURAYAMA, Tokyo (JP); Kazuma KAWAHARA, Tokyo (JP); Hiroaki SHIMODA, Tokyo (JP); Toshihiko YOSHIDA, Tokyo (JP)

(73) Assignee: CASIO COMPUTER CO., LTD., Tokyo (JP)

(21) Appl. No.: 15/499,034

(22) Filed: Apr. 27, 2017

(30) Foreign Application Priority Data
Jun. 22, 2016 (JP) 2016-123105

(51) Int. Cl. G06Q 30/02; H04H 20/93; H04H 20/38

(52) U.S. Cl. CPC G06Q 30/0267; H04H 20/38; H04H 20/93

(57) ABSTRACT

A content output device includes: a display that outputs content; a communication unit that transmits at least one piece of beacon information correlated to the content which is being output by the display; and a CPU that makes responsive period information or unresponsive period information for a communication device based on the content which is being output by the display, and causes the communication unit to transmit the beacon information containing the responsive period information or the unresponsive period information, wherein the responsive period information or the unresponsive period information indicates a period which the communication device executes or does not execute an action corresponding to the received beacon information.

### BACKGROUND OF THE INVENTION

### Field of the Invention

The present invention relates to a content output device, a method of outputting content, and a computer readable medium.

### Description of the Related Art

A recent system for enhancing the ability to attract customers includes a digital signage device which displays content and includes a beacon transmitting unit, for example. The digital signage device displays a first content, such as an advertisement or guidance, and causes the beacon transmitting unit to broadcast beacon information including identification (ID) information corresponding to information related to the first content. In the system, a communication device receiving the beacon information displays a second content in association with the first content.

In the system disclosed in Japanese Patent Application Laid-Open Publication No. 2015-222880, every time when entering the communication area of the beacon transmitting unit of the digital signage device while the digital signage device is displaying the first content, the communication device displays the second content related to the first content in response to the beacon information. If the second content is a coupon for the merchandise advertised in the first content, the system may provide redundant or duplicative information, for example, the same coupons in several times in a day to a user of the communication device.

### SUMMARY OF THE INVENTION

An object of the present invention is to enable controlling a responsive period of a communication device to beacon information depending on content.

To achieve the above object, a content output device in which one aspect of the present invention is reflected includes: a display that outputs content; a communication unit that transmits at least one piece of beacon information correlated to the content which is being output by the display; and a CPU that makes responsive period information or unresponsive period information for a communication device based on the content which is being output by the display, and causes the communication unit to transmit the beacon information containing the responsive period information or the unresponsive period information, wherein the responsive period information or the unresponsive period information indicates a period which the communication device executes or does not execute an action corresponding to the received beacon information.

According to the present invention, the responsive period of the communication device to the beacon information can be controlled depending on content.

### BRIEF DESCRIPTION OF THE SEVERAL VIEWS OF THE DRAWINGS

The above and further objects, features and advantages of the present invention will be made clearer by the following detailed description and the attached drawings, in which:

FIG. 1 illustrates an overall configuration of a content output system according to an embodiment of the present invention;

FIG. 2 is a block diagram of a functional configuration of a digital signage device illustrated in FIG. 1;

FIG. 3 is a schematic view of a screen unit illustrated in FIG. 2;

FIG. 4 is a block diagram of a functional configuration of a portable terminal illustrated in FIG. 1;

FIG. 5 is a flow chart of a content outputting process executed by a controller illustrated in FIG. 2;

FIG. 6 is a flow chart of a beacon receiving process executed by a controller illustrated in FIG. 4; and

FIG. 7 illustrates an exemplary operation of the portable terminal upon execution of the beacon receiving process.

### DETAILED DESCRIPTION OF THE PREFERRED EMBODIMENTS

Embodiments of the present invention will now be described in detail with reference to the accompanying drawings. The following is an embodiment where a content output device of the present invention is applied to a digital signage device 1. It should be noted that the accompanying drawings should not be construed to limit the present invention.

### [Configuration of Content Output System 100]

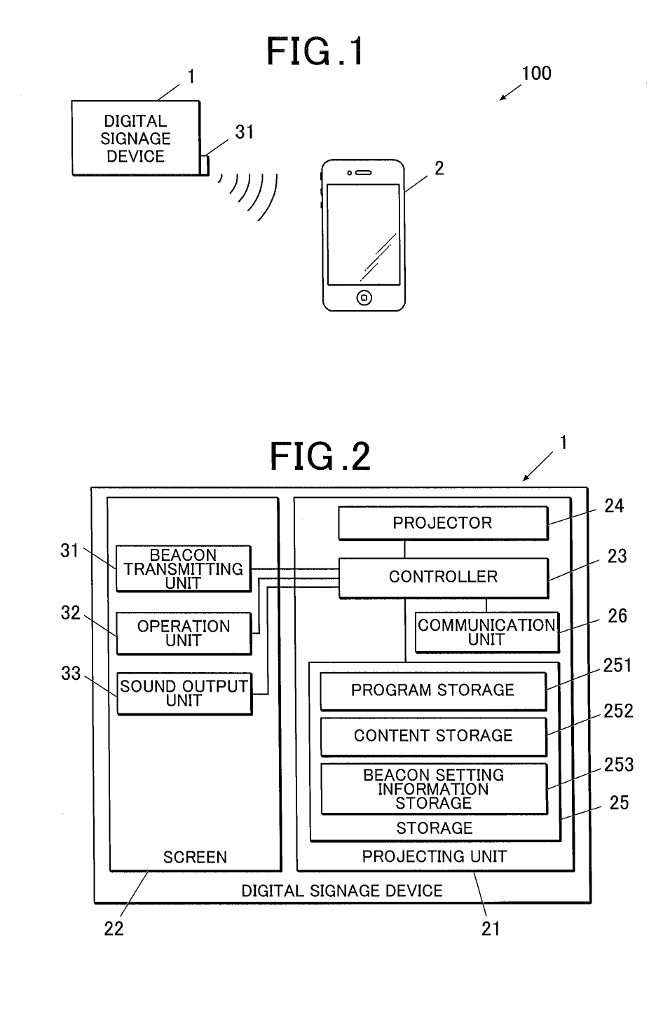

FIG. 1 illustrates an overall configuration of a content output system 100 according to an embodiment of the present invention. As illustrated in FIG. 1, the content output system 100 includes a digital signage device 1 and a portable terminal 2. The digital signage device 1 includes a beacon transmitting unit 31 that can establish a near field wireless communication with the portable terminal 2 through the Bluetooth (registered trademark) scheme.

### [Configuration of Digital Signage Device 1]

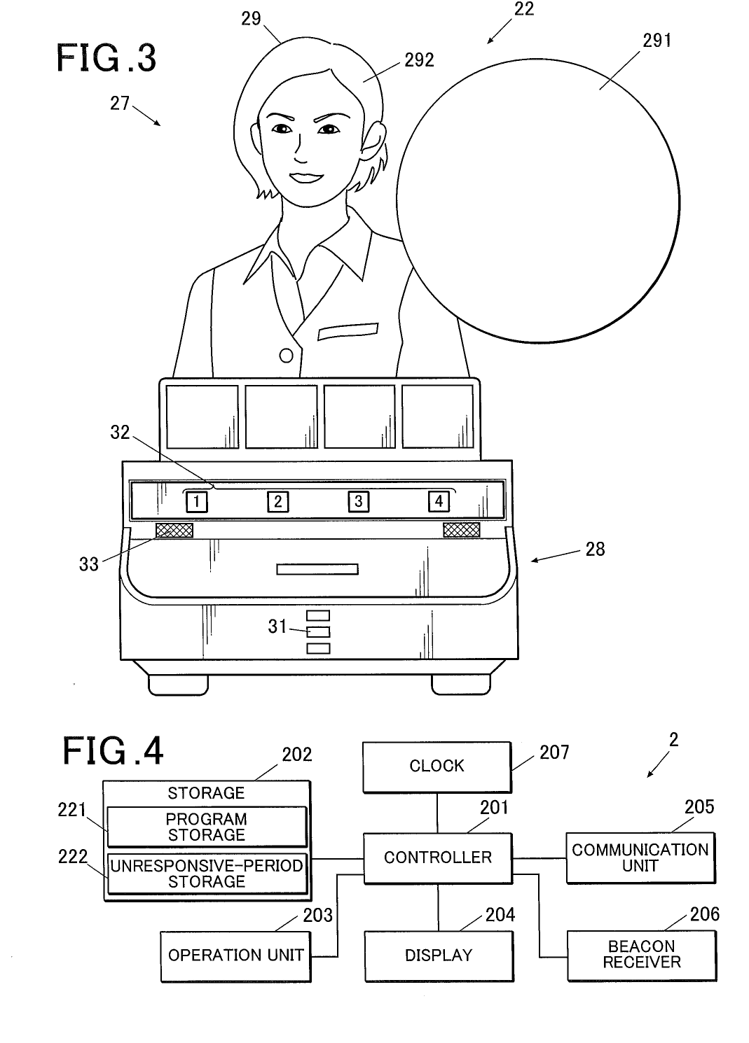

FIG. 2 is a block diagram of a main control configuration of the digital signage device 1 according to the embodiment. FIG. 3 is a schematic front view of a screen 22 illustrated in FIG. 2. For example, the digital signage device 1 is disposed in a shop, and outputs content, such as an advertisement or guidance, to customers.

With reference to FIG. 2, the digital signage device 1 includes a projecting unit 21 which emits light of video images of content, and a screen 22 which receives the light of video images from the projecting unit 21 at its rear face and displays the projected video images on its front face.

The projecting unit 21 will now be described in detail.

The projecting unit 21 includes a controller 23, a projector 24, a storage 25, and a communication unit 26. As illustrated in FIG. 2, the projector 24, the storage 25, and the communication unit 26 are connected to the controller 23.

The controller 23 includes a central processing unit (CPU) and a memory (that are not shown). The CPU runs various programs stored in the storage 25 to carry out a predetermined operation and control of each unit. The memory serves as a working area of the running programs. The controller 23 carries out a content outputting process described below in cooperation with the programs stored in a program storage 251 in the storage 25.

The projector 24 is a projecting device which converts image data of content output from the controller 23 into light of video images and emits the light of video images to the screen 22. For example, the projector 24 is a digital light processing (DLP) (registered trademark) projector utilizing a digital micromirror device (DMD). The DMD is a display device which includes an array of microscopic mirrors (1024(width) by 768(length) pixels for XGA) and individually adjusts an inclination of each mirror at high speed such that the mirror has an on or off state to execute a displaying operation. The displaying operation forms an optical image with light reflected on the mirrors.

The storage 25 is composed of a hard disk drive (HDD) or a nonvolatile semiconductor memory, for example. With reference to FIG. 2, the storage 25 includes a program storage 251, a content storage 252, and a beacon setting information storage 253.

The program storage 251 stores a system program and various processing programs to be executed by the controller 23, and data for execution of the programs.

The content storage 252 stores content information (content data) in connection with a content identification (ID) for identifying content. The digital signage device 1 outputs content in reference to the content information. The content information includes moving image data composed of plural frame images and sound data corresponding to each flame image, for example. Alternatively, the content information may include only image data (still image data or moving image data). In this embodiment, the content storage 252 stores the content information on Content A and the content information on Content B.

The beacon setting information storage 253 stores time information in connection with the content ID. During output of content, the beacon transmitting unit 31 transmits beacon information including the content ID and the time information. The time information indicates an unresponsive period of a beacon application (described in detail below) of the portable terminal 2 with respect to another reception, after reception of the beacon information, of the same beacon information including the same content ID as that of the former received beacon information (i.e., a period which the beacon application does not perform any action in response to another reception of the same beacon information). The format of the time information may be “X hours”, “Y minutes”, or “A hours and B minutes to C hours and D minutes”, for example. In this embodiment, the time information is in the format of “X hours” and/or “Y minutes”.

The information stored in the beacon setting information storage 253 can be updated with the new one from a server (not shown) through the communication unit 26 as needed.

The communication unit 26 includes a modem, a router, a network card, and any other component. The communication unit 26 communicates with an external device through a communication network.

The screen 22 will now be described in detail.

With reference to FIG. 3, the screen 22 includes an image formation unit 27 and a base 28 supporting the image formation unit 27.

The image formation unit 27 is a screen disposed substantially perpendicular to the direction of the incident light of video images. The screen includes a light transmissive plate 29 formed as a human-shaped acrylic board, and on the light transmissive plate 29, a rear-projection film screen 291 composed of a laminate of Fresnel lens films and/or a film 292 having an image of a human preliminary printed thereon are pasted, for example. The projector 24 projects images onto a region of the film screen 291 pasted on the light transmissive plate 29 of the image formation unit 27. Alternatively, the film screen 291 may be laminated over the light transmissive plate 29 and an image of a human may be projected on the film screen 291.

The base 28 includes a beacon transmitting unit 31, an operation unit 32 of a push-button type, and a sound output unit 33, such as a speaker.

The beacon transmitting unit 31 is a communication unit which broadcasts the beacon information including the content ID and the time information of the content, which is being output with preset transmission intensity, through the Bluetooth Low Energy (BLE) communication at a predetermined time interval.

With reference to FIG. 2, the beacon transmitting unit 31, the operation unit 32, and the sound output unit 33 are connected to the controller 23.

The projector 24, the image formation unit 27, and the sound output unit 33 function as an output unit. [Configuration of portable terminal 2]

FIG. 4 is a block diagram of a main control configuration of the portable terminal 2. The portable terminal 2 is a communication device, such as a smartphone or a cell-phone, carried by a customer. As illustrated in FIG. 4, the portable terminal 2 includes a controller 201, a storage 202, an operation unit 203, a display 204, a communication unit 205, a beacon receiver 206, a clock 207, and any other component.

The controller 201 includes a central processing unit (CPU) (not shown) and a memory (that are not shown). The CPU runs various programs stored in a program storage 221 in the storage 202 to carry out a predetermined operation and control of each unit. The memory serves as a working area of the running programs. The controller 201 executes various processing including a beacon receiving process described below in cooperation with the programs stored in the program storage 221 of the storage 202.

The storage 202 is a nonvolatile semiconductor memory, for example. With reference to FIG. 4, the storage 202 includes the program storage 221. The program storage 221 stores a system program and programs for various applications including a beacon application to be executed by the controller 201, and data for execution of these programs. The beacon application is a dedicated application program that executes an action corresponding to the beacon information (in detail, the content identified with the content ID contained in the beacon information) received at the beacon receiver 206.

The storage 202 also includes an unresponsive period storage 222. The unresponsive period storage 222 stores, in connection with the content ID, a reception date and time of the beacon information containing the content ID, and the time information obtained from the beacon information.

The operation unit 203 is provided with several functional keys. In response to key strokes by a user, the operation unit 203 transmits information on the instructed operation to the controller 201. The operation unit 203 is also provided with a touch panel composed of a grid of transparent electrodes and covering the display 204. The operation unit 203 detects each position pressed with a finger or a stylus on the touch panel and transmits obtained positional information to the controller 201.

The display 204 is a liquid crystal display (LCD), for example. The display 204 performs various displays in response to display control signals from the controller 201.

The communication unit 205 is wirelessly connected to a communication network via a base station or an access point to communicate with an external device in connection with the communication network.

The beacon receiver 206 establishes a near field wireless communication with an external beacon transmitting device, such as the beacon transmitting unit 31 of the digital signage device 1, through the Bluetooth Low Energy (BLE) communication, and receives the beacon information transmitted from the beacon transmitting device.

The clock 207 is composed of a real-time clock (RTC), for example. The clock 207 acquires a current date and time and transmits the acquired current date and time to the controller 201.

### [Operation of Content Output System 100]

The operation of the content output system 100 according to the embodiment will now be described.

The operation of the digital signage device 1 will now be described first.

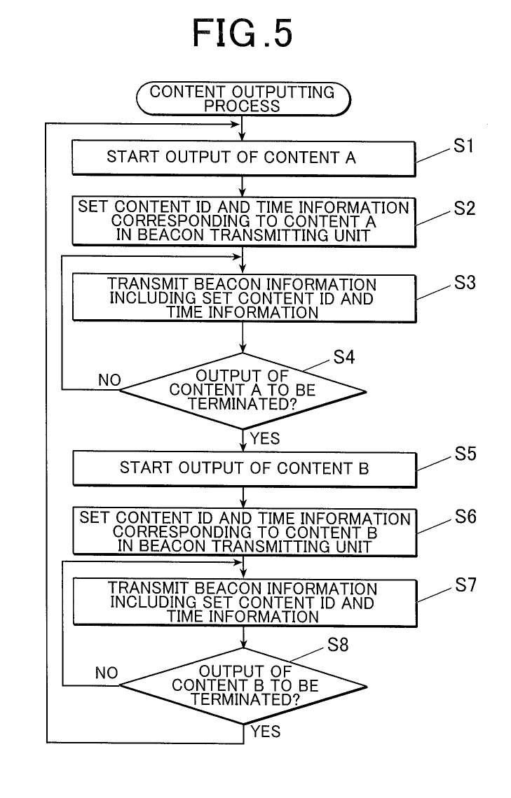

FIG. 5 is a flow chart of a content outputting process executed by the digital signage device 1. The content outputting process is executed by the controller 23 in cooperation with the programs stored in the program storage 251 upon the turning-on of the digital signage device 1.

The controller 23 causes the projector 24 and the sound output unit 33 to start output of Content A (Step S1). In detail, the controller 23 reads the content information of Content A stored in the content storage 252, and causes the projector 24 to project the images of Content A based on the moving image data in the read content information such that the images are displayed on the image formation unit 27. The controller 23 also causes the sound output unit 33 to output sounds of Content A based on sound data of the read moving image data.

The controller 23 then obtains the time information corresponding to Content A from the beacon setting information storage 253, and sets the content ID for identifying Content A and the obtained time information in the beacon transmitting unit 31 (Step S2). By obtaining the time information corresponding to the currently-output content from the beacon setting information storage 253, the controller 23 determines the unresponsive period of the portable terminal 2 to the beacon information correlated to the currently-output content, and sets the unresponsive period as the time information in the beacon transmitting unit 31.

The controller 23 then causes the beacon transmitting unit 31 to transmit (broadcast) the beacon information including the set content ID and time information (Step S3).

The controller 23 then determines whether to terminate the output of Content A (Step S4). For example, the determination in Step S4 may be conducted based on a predetermined schedule, or may be conducted based on a detection signal from a motion detector disposed in the digital signage device 1.

If the controller 23 determines not to terminate the output of Content A (NO in Step S4), the procedure returns to Step S3.

If the controller 23 determines to terminate the output of Content A (YES in Step S4), the controller 23 causes the projector 24 and the sound output unit 33 to start output of Content B (Step S5). In detail, the controller 23 reads the content information of Content B stored in the content storage 252, and causes the projector 24 to project the images of Content B based on the moving image data in the read content information such that the images are displayed on the image formation unit 27. The controller 23 also causes the sound output unit 33 to output sounds of Content B based on sound data of the read moving image data.

The controller 23 then obtains the time information corresponding to Content B from the beacon setting information storage 253, and sets the content ID for identifying Content B and the obtained time information in the beacon transmitting unit 31 (Step S6).

The controller 23 then causes the beacon transmitting unit 31 to broadcast the beacon information including the set content ID and time information (Step S7).

The controller 23 then determines whether to terminate the output of Content B (Step S8). If the controller 23 determines not to terminate the output of Content B (NO in Step S8), the procedure returns to Step S7.

If the controller 23 determines to terminate the output of Content B (YES in Step S8), the procedure returns to Step S1.

The controller 23 repeats the cycle including Steps S1 to S8 while the digital signage device 1 is turned on.

The operation of the portable terminal 2 will now be described.

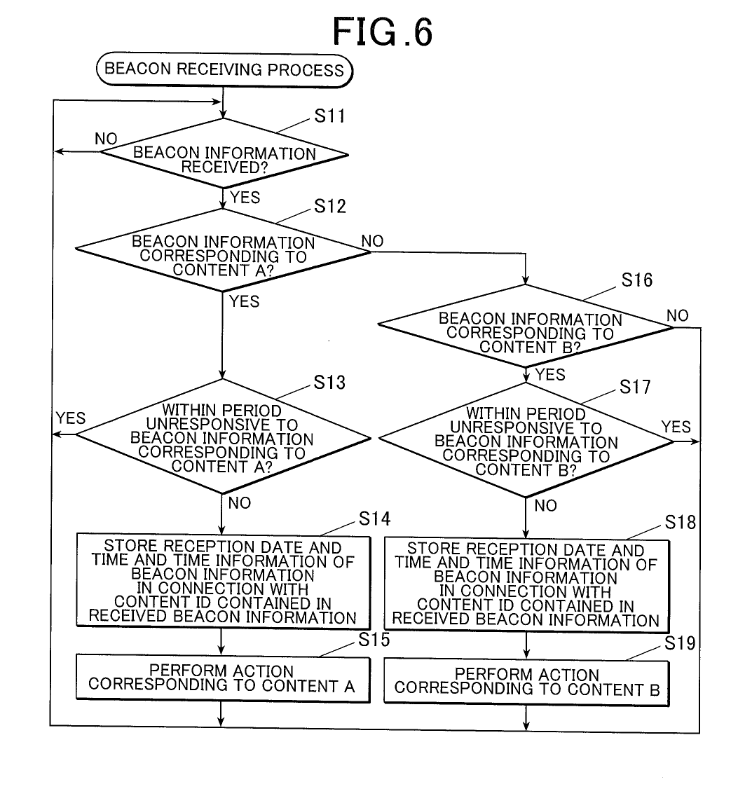

FIG. 6 is a flow chart of a beacon receiving process executed at the portable terminal 2. The beacon receiving process is executed by the controller 201 in cooperation with the beacon application stored in the program storage 221 upon the turning-on of the portable terminal 2.

The controller 201 waits for reception of the beacon information at the beacon receiver 206.

Upon the reception of the beacon information at the beacon receiver 206 (YES in Step S11), the controller 201 determines whether the received beacon information is the beacon information correlated to Content A based on the content ID contained in the beacon information (Step S12).

If the controller 201 determines that the received beacon information is the beacon information correlated to Content A (YES in Step S12), the controller 201 determines whether the current time is within the unresponsive period with respect to the beacon information correlated to Content A, in reference to the unresponsive period storage 222 and the current time transmitted from the clock 207 (Step S13).

If the controller 201 determines that the current time is within the unresponsive period with respect to the beacon information correlated to Content A (YES in Step S13), the procedure returns to Step S11.

If the controller 201 determines that the current time is not within the unresponsive period with respect to the beacon information correlated to Content A (NO in Step S13), the controller 201 causes the unresponsive period storage 222 to store the reception date and time and the time information of the beacon information in connection with the content ID contained in the received beacon information (Step S14). In other words, the unresponsive period storage 222 stores information on the unresponsive period which the beacon application does not respond to the beacon information correlated to Content A.

The controller 201 then performs an action corresponding to the received beacon information, i.e., an action corresponding to Content A (Step S15). The procedure then returns to Step S11.

If the controller 201 determines that the received beacon information is not the beacon information correlated to Content A in Step S12 (NO in Step S12), the controller 201 determines whether the received beacon information is the beacon information correlated to Content B (Step S16). If the controller 201 determines that the received beacon information is not the beacon information correlated to Content B (NO in Step S16), the procedure returns to Step S11.

If the controller 201 determines that the received beacon information is the beacon information correlated to Content B (YES in Step S16), the controller 201 determines whether the current time is within the unresponsive period with respect to the beacon information correlated to Content B, in reference to the unresponsive period storage 222 and the current time transmitted from the clock 207 (Step S17).

If the controller 201 determines that the current time is within the unresponsive period with respect to the beacon information correlated to Content B (YES in Step S17), the procedure returns to Step S11.

If the controller 201 determines that the current time is not within the unresponsive period with respect to the beacon information correlated to Content B (NO in Step S17), the controller 201 causes the unresponsive period storage 222 to store the reception date and time and the time information of the beacon information in connection with the content ID contained in the received beacon information (Step S18). In other words, the unresponsive period storage 222 stores information on the unresponsive period which the beacon application does not respond to the beacon information correlated to Content B.

The controller 201 then causes an action corresponding to the received beacon information, i.e., an corresponding to Content B (Step S19). The procedure then returns to Step S11.

The controller 201 repeats the cycle including Steps S11 to S19 while the portable terminal 2 is turned on.

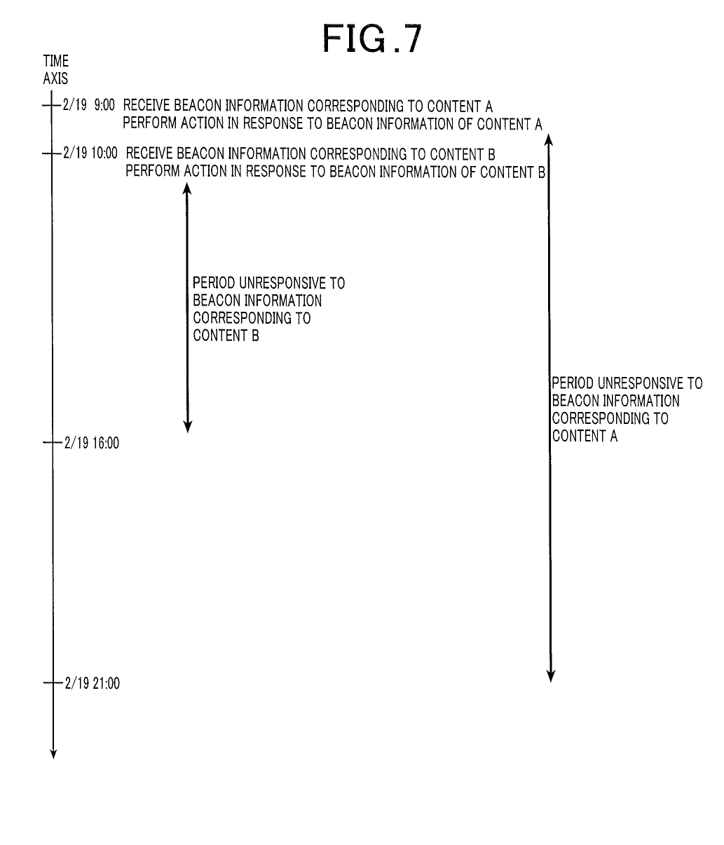

FIG. 7 illustrates an exemplary operation of the portable terminal 2 during the beacon receiving process described above.

For example, when the portable terminal 2 carried by a user enters the communication area of the beacon transmitting unit 31 at 9:00 on February 19 and receives the beacon information (time information: 12 hours) correlated to Content A which is being output at the digital signage device 1, the beacon application performs an action corresponding to the beacon information of Content A and becomes unresponsive to (does not perform any action in response to) the beacon information correlated to Content A for subsequent 12 hours (i.e., until 21:00 on February 19).

When the same portable terminal 2 carried by the user enters the communication area of the beacon transmitting unit 31 again at 10:00 on February 19 and receives the beacon information (time information: 6 hours) correlated to Content B which is being output at the digital signage device 1, the beacon application performs an action corresponding to the beacon information of Content B and becomes unresponsive to the beacon information which is being output at Content B for subsequent 6 hours (i.e., until 16:00 on February 19).

When the same portable terminal 2 carried by the user enters the communication area of the beacon transmitting unit 31 after 16:00 on February 19 and receives the beacon information correlated to Content B which is being output at the digital signage device 1, the beacon application responds to the received beacon information, namely, performs an action corresponding to the beacon information of Content B because the unresponsive period to Content B has passed over. In contrast, the beacon application does not respond to the beacon information correlated to Content A until 21:00 on February 19.

When the same portable terminal 2 carried by the user enters the communication area of the beacon transmitting unit 31 after 21:00 on February 19 and receives the beacon information correlated to Content A which is being output at the digital signage device 1, the beacon application responds to the received beacon information, namely, performs an action corresponding to the beacon information of Content A because the unresponsive period to Content A has passed over.

As described above, the controller 23 can control the responsive period of the portable terminal 2 to the beacon information based on the content.

In the exemplary case illustrated in FIG. 7, the action corresponding to the beacon information of Content A is to display a coupon of the merchandise advertised in Content A, and the action corresponding to the beacon information correlated to Content B is to display a coupon of the merchandise advertised in Content B. The frequency of display of the coupons for the merchandise in Content A and B at the portable terminal 2 may be varied. In the exemplary case illustrated in FIG. 7, the distribution of the coupon for the merchandise in Content B to one user is at most four times per day, and that for the merchandise in Content A is at most two times per day.

For example, if the beacon information correlated to the content for advertising merchandise includes the time information indicating one day or 24 hours, the display of the coupon for the merchandise for a single user can be restricted to one per day.

In another exemplary case, the digital signage device 1 is disposed on the entrance of a food mall. During the opening hours of the food mall, the digital signage device 1 sequentially outputs the content guiding the restaurants, and causes the beacon transmitting unit 31 to transmit the beacon information correlated to the currently-output content. In this case, by setting the time information (for example, “11:00 to 21:00” for a food mall opening from 11:00 to 21:00) for the content of a restaurant closed on the day, it becomes possible to restrict the portable terminal 2 from displaying an unavailable coupon for the restaurant closed on the day.

In still another exemplary case, the digital signage device 1 is disposed on the entrance of a shop. The digital signage device 1 repeatedly playbacks Content A to promote customers to visit the shop. When the motion detector senses a customer entering the shop, Content A is switched to Content B indicating an appreciation for the visit. The action of the beacon application corresponding to the beacon information correlated to Content A is to display an advertisement of the shop, and the action of the beacon application corresponding to the beacon information of Content B is to display a coupon for the shop. In this case, by setting the time information of Content A to 0 minute and setting the time information of Content B to 24 hours, the user of the portable terminal 2 receives an advertisement of the shop every time when the user passes by the entrance of the shop, but receives a single coupon for the shop per day.

In the embodiments described above, the time information included in the beacon information is a period which the portable terminal 2 having received first beacon information does not perform an action corresponding to second beacon information, which is same as the first beacon information, upon reception of the second beacon information (i.e., unresponsive period); however, the time information may be any other period.

In another embodiment, the time information included in the beacon information may be a period which the portable terminal 2 having received first beacon information does not perform an action corresponding to second beacon information, which is different from the first beacon information, upon reception of the second beacon information. For example, it is assumed that the digital signage device 1 outputs the content of a time-limited sale while transmitting the beacon information correlated to the content. In this case, by setting the time information to the time-limited sale hours, it becomes possible to prevent the beacon application of the portable terminal 2 from performing an action corresponding to the beacon information correlated to contents other than the content of the time-limited sale, and to cause the beacon application to preferentially perform the action related to the time-limited sale such as advertisement and display of coupons, during the time-limited sale hours.

In another embodiment, the time information included in the beacon information is a period which the portable terminal 2 having received beacon information from a first source does not perform an action corresponding to beacon information from a second source, which is different from the first source, upon reception of the beacon information from the second source. For example, plural digital signage devices 1 are provided which output different content. A certain digital signage device 1 outputs the content of a time-limited sale while transmitting the beacon information correlated to the content. In this case, by setting the time information to the time-limited sale hours, it becomes possible to prevent the beacon application of the portable terminal 2 from performing an action corresponding to beacon information transmitted from any digital signage devices 1 other than the certain digital signage device 1, and to cause the beacon application to preferentially perform the action related to the time-limited sale such as advertisement and display of coupons, during the time-limited sale hours. The beacon information includes a terminal identification (ID) for identifying the digital signage device 1 as the source, and the portable terminal 2 can identify the source of the received beacon information with the terminal ID.

In another embodiment, the time information included in the beacon information is not an unresponsive period but a responsive period. For example, the time information is a period which the portable terminal 2 having received the beacon information continues the action corresponding to the beacon information. In an exemplary case, the digital signage device 1 outputs the content of a time-limited sale, and the action of the portable terminal 2 corresponding to the beacon information correlated to the output content is a pop-up display of coupons that can be used in the time-limited sale. In this case, by setting the time information to the time-limited sale hours, it becomes possible to cause the beacon application of the portable terminal 2 to continue the pop-up display of coupons for the time-limited sale on the display 204 during the time-limited sale hours. The portable terminal 2 may terminate the display of coupons at the end of the time-limited sale hours.

As described above, the controller 23 of the digital signage device 1 can determine the responsive or unresponsive period of the beacon application of the portable terminal 2 with respect to beacon information based on the output content, and can cause the beacon transmitting unit 31 to transmit the beacon information including the responsive or unresponsive period.

Accordingly, the responsive period of the portable terminal 2 to the beacon information can be controlled depending on the content.

It should be noted that the embodiments of the content output system described above are mere preferred examples of the present invention and thus should not be construed to limit the invention.

In the embodiments described above, the digital signage device 1 outputs two content (Content A and B); however, the digital signage device 1 can output any number of content and any content.

In the embodiments described above, the present invention is applied to the example where the information which is to be transmitted and includes the ID information is broadcast through the Bluetooth Low Energy (BLE) communication; however, the information may be transmitted through any communication scheme. In another embodiment of the present invention, the information which is to be transmitted and includes the ID information is broadcast through an ultrasonic communication.

In the embodiments described above, the present invention is applied to the digital signage device which displays the images projected from the projector on the screen; however, these embodiments are mere non-limiting example and the present invention may be applied to any content playback device including any other display device, such as a liquid-crystal display or a plasma display that can achieve the advantageous effects described above.

The detail configuration and operation of the devices/units of the content output system can be appropriately modified without departing from the scope of the present invention.

The embodiments described above should not be construed to limit the present invention, and the claims and other equivalents thereof are included in the scope of the invention.

This application is based upon and claims the benefit of priority from the prior Japanese Patent Application No. 2016-123105 filed on Jun. 22, 2016, the entire contents of which are incorporated herein by reference.

What is claimed is:

1. A content output device comprising:
a display that outputs content;
a communication unit that transmits at least one piece of beacon information correlated to the content which is being output by the display; and
a CPU that makes responsive period information or unresponsive period information for a communication device based on the content which is being output by the display, and causes the communication unit to transmit the beacon information containing the responsive period information or the unresponsive period information,
wherein the responsive period information or the unresponsive period information indicates a period which the communication device executes or does not execute an action corresponding to the received beacon information.

2. The content output device according to claim 1, wherein the responsive period information indicates a period which the communication device continues the action corresponding to the beacon information correlated to the content which is being output by the output unit.

3. The content output device according to claim 1, wherein the unresponsive period information indicates a period which the communication device having received first beacon information, among plural pieces of the beacon information, correlated to the content which is being output by the display does not execute the action upon reception of second beacon information among plural pieces of the beacon information, the second beacon information being same as the first beacon information.

4. The content output device according to claim 1, wherein the unresponsive period information indicates a period which the communication device having received first beacon information, among plural pieces of the beacon information, correlated to the content which is being output by the output unit does not execute the action corresponding to second beacon information among plural pieces of the beacon information upon reception of the second beacon information, the second beacon information being different from the first beacon information.

5. The content output device according to claim 4, wherein the second beacon information is correlated to content different from the content of the first beacon information.

6. The content output device according to claim 4, wherein the first beacon information and the second beacon information are transmitted from different sources, respectively.

7. The content output device according to claim 1, wherein the responsive period information or the unresponsive period information with respect to the beacon information is a responsive or unresponsive period of a beacon application installed in the communication device, the beacon application executing the action corresponding to the received beacon information.

8. An outputting method comprising the steps of:
displaying content;
transmitting beacon information correlated to the content which is being output; and
making information on responsive period information or unresponsive period information for a communication device based on the content which is being displayed, and transmitting the beacon information containing the responsive period information or the unresponsive period information,
wherein the responsive period information or the unresponsive period information indicates a period which the communication device executes or does not execute an action corresponding to the received beacon information.

9. A non-transitory computer readable medium recording a program readable by a computer of a content output device which includes: a display that outputs content; and a communication unit that transmits beacon information correlated to the content which is being output by the output unit, wherein
the program causes the computer to perform:
a controlling process to make information on responsive period information or unresponsive period information for a communication device based on the content which is being displayed, and transmit the beacon information containing the responsive period information or the unresponsive period information,
wherein the responsive period information or the unresponsive period information indicates a period which the communication device executes or does not execute an action corresponding to the received beacon information.
